(19) United States
(12) Patent Application Publication
(10) Pub. No.: US 2026/0112968 A1
(43) Pub. Date: Apr. 23, 2026

(54) POWER SUPPLY AND MULTI-TAPPED AUTOTRANSFORMER IMPLEMENTATIONS

(71) Applicant: Infineon Technologies Austria AG, Villach (AT)

(72) Inventors: Kevin ZUFFERLI, Fagagna (IT); Roberto RIZZOLATTI, Villach (AT); Mario URSINO, Villach (AT)

(21) Appl. No.: 18/921,250

(22) Filed: Oct. 21, 2024

(51) Int. Cl. H02M 3/07

(52) U.S. Cl. CPC H02M 3/07

(57) ABSTRACT

An apparatus such as a switched-capacitor converter as discussed herein includes: multiple capacitors; a multi-tapped autotransformer including a first primary winding and a second primary winding, the multiple capacitors disposed in circuit paths of the switched-capacitor converter including the first primary winding and the second primary winding, the first primary winding includes a first tap node to receive first current, the second primary winding including a second tap node to receive second current; and an output stage coupled to receive energy from a combination of the first primary winding and the second primary winding of the multi-tapped autotransformer, the output stage operable to produce an output voltage to power a load.

### BACKGROUND

As its name suggests, a conventional switched-capacitor DC-DC converter converts a received DC input voltage into a DC output voltage.

In one conventional application, the input voltage to the conventional switched-capacitor converter falls in a range between 40 VDC to 60 VDC. In such an instance, switches in the switched-capacitor converter are controlled to transfer charge stored in capacitors, resulting in conversion of the input voltage such as a 48 VDC to an output voltage such as 12 VDC for a so-called 4:1 switched-capacitor converter. In other words, a conventional switched-capacitor converter can be configured to convert a 48 VDC voltage into a 12 VDC voltage.

A multi-tapped autotransformer is a specific type of electrical transformer sometimes used in power supply applications. A multi-tapped autotransformer has only one continuous winding. In a multi-tapped autotransformer, portions of the same winding can be used to function as both primary and secondary sides of the multi-tapped autotransformer.

Traditionally, data center equipment operates using a 48 VDC input voltage, or alternatively, a variable input voltage ranging from 40 VDC to 60 VDC, rather than the common 12 VDC bus. This preference for higher DC voltages offers several advantages, including reduced distribution losses within the server rack and motherboard. Various conventional methods are employed to deliver higher power per rack and per board, often involving the conversion of the input voltage into one or more output voltages.

### BRIEF DESCRIPTION

This disclosure includes the observation that power conversion efficiency of power supplies can be improved. For example, to this end, examples herein include novel magnetic devices, transformer devices, and methods of fabricating same to provide efficient generation of a corresponding output voltage.

More specifically, as discussed herein, an apparatus (such as a switched capacitor converter or other suitable entity) includes: multiple capacitors, a multi-tapped autotransformer, and an output stage. The multi-tapped autotransformer can be configured to include a first primary winding and a second primary winding. The multiple capacitors may be disposed in circuit paths of the switched-capacitor converter including the first primary winding and the second primary winding. The first primary winding can be configured to include a first tap node to receive first current. The second primary winding can be configured to include a second tap node to receive second current. The output stage of the apparatus can be configured to produce an output voltage to power a load based on energy received from a combination of the first primary winding and the second primary winding of the multi-tapped autotransformer.

In accordance with further examples, the multi-tapped autotransformer as discussed herein can be configured to include a first secondary winding and a second secondary winding inductively coupled to the first primary winding and the second primary winding. The output stage can be configured to include the first secondary winding and the second secondary winding. Yet further, a third tap node of the multi-tapped autotransformer can be configured to directly couple the first secondary winding and the second secondary winding in series, the third tap node can be configured to output the output voltage. Yet further, a fourth tap node of the multi-tapped autotransformer can be configured to directly couple the first primary winding to the first secondary winding; the fifth tap node of the multi-tapped autotransformer can be configured to directly couple the second primary winding to the second secondary winding. The switched circuit paths as discussed herein may include any number of resonant circuit path such as: i) a first resonant circuit path coupled to the first tap node of the first primary winding via a first switch, the first resonant circuit path including a first capacitor of the multiple capacitors, and ii) a second resonant circuit path coupled to the second tap node of the second primary winding via a second switch, the second resonant circuit path including a second capacitor of the multiple capacitors.

The switched-capacitor converter as discussed herein may further include: first switch circuitry directly coupled to the first tap node, the first switch circuitry operative to control flow of the first current into the first tap node and through a first portion of the first primary winding; and second switch circuitry directly coupled to the second tap node, the second switch circuitry operative to control flow of the second current into the second tap node and through a first portion of the second primary winding. In one example, the first portion of the first primary winding may be directly connected between the first tap node and a first node of the first secondary winding; and the first portion of the second primary winding may be connected between the second tap node and a first node of the second secondary winding. The switched-capacitor converter can be configured to further include: third switch circuitry directly connected between the first node of the first secondary winding and a ground reference; and fourth switch circuitry directly connected between the first node of the second secondary winding and the ground reference.

Yet further, the multiple capacitors can be configured to include a first resonant capacitor and a second resonant capacitor. The first resonant capacitor may be disposed in series with the second primary winding; the second resonant capacitor may be disposed in series with the first primary winding. The switched-capacitor converter may further include: a controller operative to: i) charge the first resonant capacitor during a first portion of a control cycle of operating the switched-capacitor converter to convert an input voltage into the output voltage, and ii) discharge the second resonant capacitor during the first portion of the control cycle of operating the switched-capacitor converter, the second capacitor discharged via the second current inputted to the second tap node of the second primary winding. The controller can be configured to: i) discharge the first resonant capacitor during a second portion of the control cycle of operating the switched-capacitor converter to convert the input voltage into the output voltage, the second capacitor discharged via the first current inputted to the first tap node of the first primary winding, and ii) charge the second resonant capacitor during the second portion of the control cycle of operating the switched-capacitor converter.

Yet further examples as discussed herein a method comprising: switching multiple capacitors of a switched-capacitor converter in circuit paths of the switched capacitor converter, where the switching controls flow of first current into a first tap node of a first primary winding and second current into a second tap node of a second primary winding of a multi-tapped autotransformer; and producing an output voltage based on energy received from a combination of the first primary winding and the second primary winding of the multi-tapped autotransformer.

These and other more specific examples are disclosed in more detail below.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a switched-capacitor converter including multiple tapped primary windings as discussed herein.

FIG. 2 is an example diagram illustrating a multi-tapped autotransformer including one or more tapped primary windings and corresponding one or more secondary winding as discussed herein.

FIG. 3 is an example diagram illustrating details of a switched capacitor power converter including tapped primary windings as discussed herein.

FIG. 4 is an example timing diagram illustrating timing of control signals as discussed herein.

FIG. 5 is an example diagram illustrating a timing diagram of control signals and output signals as discussed herein.

FIG. 6A is an example diagram illustrating a first mode of operating the switched capacitor converter as discussed herein.

FIG. 6B is an example diagram illustrating a first mode of operating the switched capacitor converter as discussed herein.

FIG. 7A is an example diagram illustrating flow of currents through a multi-tapped autotransformer and generation of a corresponding output voltage during a first mode as discussed herein.

FIG. 7B is an example diagram illustrating flow of currents through a multi-tapped autotransformer and generation of a corresponding output voltage during a first mode as discussed herein.

FIG. 8 is a side view diagram illustrating magnetically permeable material associated with the multi-tapped autotransformer of FIG. 7 discussed herein.

FIG. 9A is an example diagram illustrating flow of current through a multi-tapped autotransformer and generation of a corresponding output voltage during a first mode as discussed herein.

FIG. 9B is an example diagram illustrating flow of current through a multi-tapped autotransformer and generation of a corresponding output voltage during the first mode as discussed herein.

FIG. 10A is an example diagram illustrating a second mode of operating the switched capacitor converter as discussed herein.

FIG. 10B is an example diagram illustrating a second mode of operating the switched capacitor converter as discussed herein.

FIG. 11 is an example diagram illustrating a general method as discussed herein.

The foregoing and other objects, features, and advantages of examples herein will be apparent from the following more particular description herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

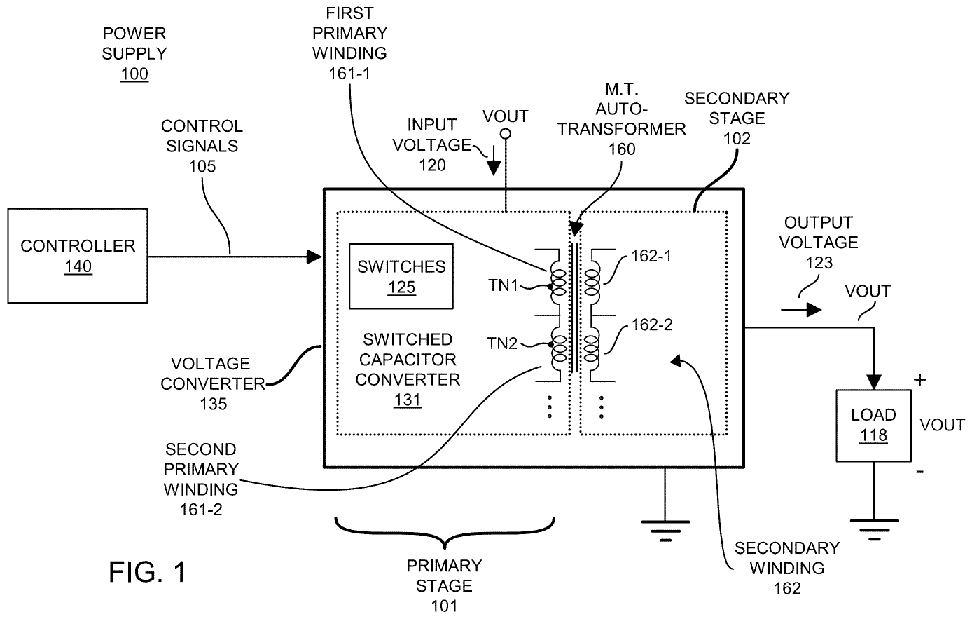

Now, more specifically, FIG. 1 is an example diagram illustrating a switched-capacitor converter (a.k.a., power converter) including a multi-tapped autotransformer according to examples herein.

As shown in this example, power supply 100 (such as an apparatus, power converter, electronic device, circuitry, hardware, etc.) includes a controller 140 and voltage converter 135 (i.e., power converter). The voltage converter 135 includes a primary stage 101 and a secondary stage 102.

Yet further, the primary stage 101 includes a switched-capacitor converter 131 comprising switches 125 (later referred to as switch Q1, switch Q2, switch Q3, switch Q4, switch Q5, and switch Q6), first primary winding 161-1, and second primary winding 161-2 of multi-tapped autotransformer 160. Note that the multi-tapped autotransformer can be configured to include any number of primary windings.

As further shown, in contrast to conventional techniques, each of the one or more primary windings of the multi-tapped autotransformer 160 can be configured to include supplemental tap nodes such as tap node TN1 in the first primary winding 161-1, supplemental tap node TN2 in the second primary winding 161-2, etc.

Note that the multi-tapped autotransformer 160 is shown by way of a non-limiting example and can be instantiated as any suitable device such as a transformer, transformer device, transformer apparatus, etc.

As further shown, the secondary stage of the power supply 100 includes secondary winding 162 of multi-tapped autotransformer 160 and related circuitry to generate output voltage 123 (Vout, such as a generally a DC voltage). Secondary windings 162 can be configured to include first secondary winding 162-1 and second secondary winding 162-2 or any number of secondary windings.

Note further that each of the resources as described herein can be instantiated in a suitable manner. For example, each of the controller 140, switched-capacitor converter 131, multi-tapped autotransformer 160 (a.k. a., multi-tapped transformer), etc., can be instantiated as or include hardware (such as circuitry), software (executable instructions), or a combination of hardware and software resources.

During operation, the controller 140 or other suitable entity produces control signals 105 (such as one or more pulse width modulation signals) that control states of respective control switches 125 in switched-capacitor converter 150.

As further shown, the voltage converter 135 (such as a so-called switched-capacitor converter or other suitable entity) can be configured to receive the input voltage 120 (Vin, such as a DC input voltage) supplied to the primary stage 101 of the voltage converter 135. As previously discussed, the multi-tapped autotransformer 160 can be configured to include a first primary winding 161-1 and a second primary winding 162-1. In one example, each of the primary windings 161 are at least inductively coupled to each other and the secondary windings 162.

In accordance with further examples, it will be shown that the primary windings 161 may be connected in series with the secondary windings 162.

As further discussed herein, controller 140 of the power supply 100 controllably switches multiple capacitors and corresponding resonant circuit paths including the primary windings 161 of multi-tapped autotransformer 160 to input energy from the input voltage (Vin) through the primary windings 161. Based on the magnetic coupling of the secondary windings to the primary windings, the secondary windings receive respective energy from the primary windings and produce the output voltage 123 (Vout) and output current 124.

Thus, in one example of a switched-capacitor converter as discussed herein includes: multiple capacitors; a multi-tapped autotransformer including a first primary winding and a second primary winding, the multiple capacitors disposed in circuit paths of the switched-capacitor converter including the first primary winding 161-1 and the second primary winding 161-2, the first primary winding 161-1 includes a first tap node TN1 to receive first current, the second primary winding 161-2 includes a second tap node TN2 to receive second current; and an output stage such as secondary stage 102 to produce an output voltage Vout to power a load 118 based on energy received from a combination of the first primary winding 161-1 and the second primary winding 161-2 of the multi-tapped autotransformer 160.

Thus, as discussed herein, transformers and/or autotransformers and corresponding primary and/or secondary windings may be tapped (TN1, TN2, . . .) to connect additional switching nodes, enabling the possibility of additional current injections in a single winding. This may optimize both efficiency and power density of the converters, as it enables to close the returning paths internally the area dedicated to the transformer or autotransformer. In other words, as further discussed herein, each of the tap nodes of respective primary windings can be injected with current to provide better efficiency of power density.

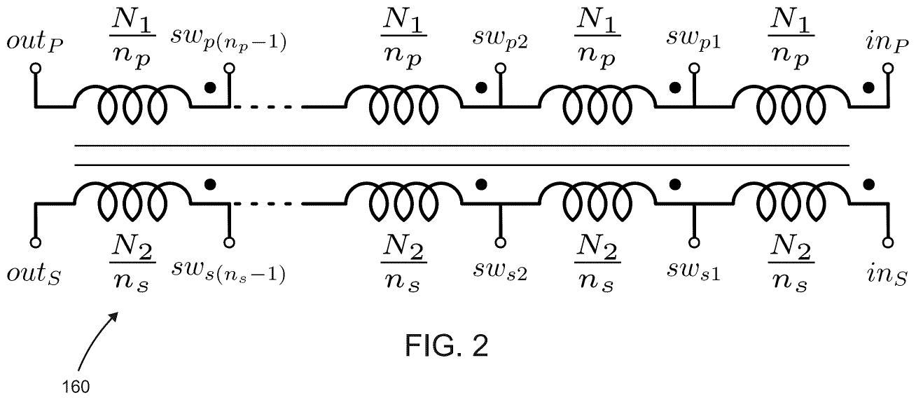

FIG. 2 is an example diagram illustrating a multi-tapped autotransformer including one or more tapped primary windings and corresponding one or more secondary winding as discussed herein.

As previously discussed, the implementation of one or more taps associated with one or more primary windings of the voltage converter 135 provides improved power conversion. As shown in FIG. 2, a primary winding of the multi-tapped autotransformer 160 implemented in the voltage converter 135 can be tapped n_p times and connected to sw_p(n_p-1) switching nodes, while the secondary winding can be tapped n_s times and connected to sw_s(n_s-1) switching nodes. Input and output of windings may be connected to anything within a corresponding circuit. For example, in one instance, an autotransformer can be created if in_P and out_S are connected.

Note further that this disclosure includes the observation that due to the switching characteristics of voltage converters, the currents passing through the switching nodes may be positive or negative. In more precise terms, throughout the various phases of power converter operation, which are determined by the states of the switches, current can be either injected into or drawn from the circuit via the corresponding tap nodes.

Moreover, this disclosure includes the observation that different primary and secondary switching nodes may be connected, resembling different winding configurations depending on the phase, considering that the magnetic energy charging/discharging behavior of the core is respected. This may offer several degrees of freedom, including the possibility to close the returning paths within the windings. In such an instance, no additional copper is needed outside the core area of the autotransformer, improving efficiency and power density. Such a connection is possible when the isolation is not required, hence the implementation of the multi-tapped autotransformer as discussed herein is useful in certain applications.

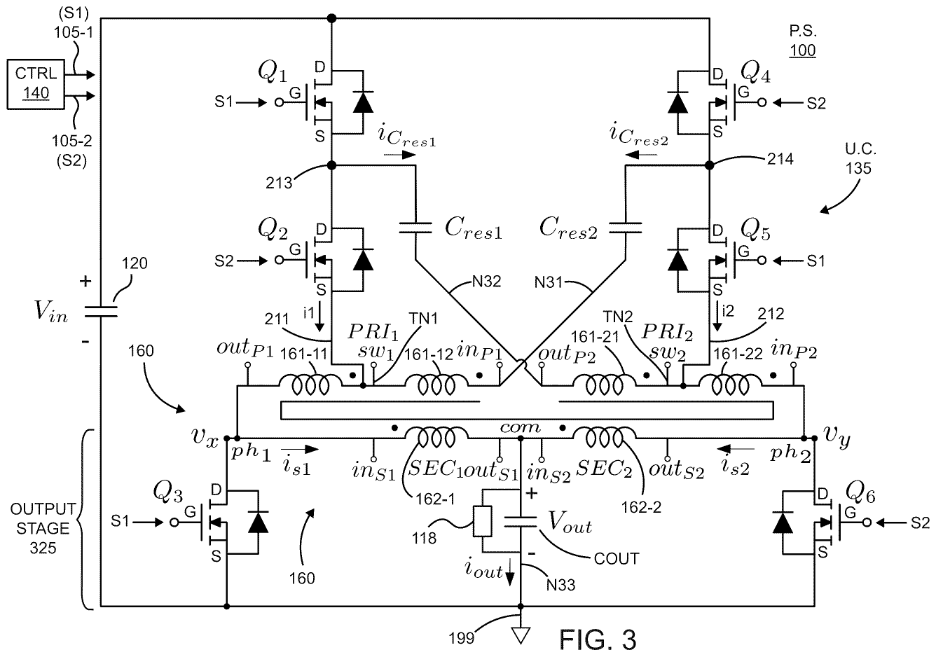

As further discussed herein in more detail, one implementation of the multi-tapped autotransformer including supplemental tap nodes on the one or more primary windings is a switched capacitor power converter as shown in FIG. 3.

FIG. 3 is an example diagram illustrating details of a switched capacitor converter including tapped primary windings as discussed herein.

As shown, the power supply 100 includes voltage source 120, voltage converter 135, and controller 140. As previously discussed, the voltage converter 135 includes multiple switches 125 (such as switches Q1, Q2, Q3, Q4, Q5, and Q6) and the multi-tapped autotransformer 160. More specifically, the input voltage source 120 supplies the input voltage Vin to the switches Q1 and Q2. In one example, the voltage converter 135 (apparatus such as hardware, circuitry, etc.) includes multiple switches Q1, Q2, Q3, Q4, Q5, and Q6 implemented as field effect transistors or any other suitable type of switch.

Additionally, note that the voltage converter 135 includes multiple circuit components including a resonant capacitor Cres1, resonant capacitor Cres2, and output capacitor Cout.

Further in this example, the multi-tapped autotransformer 160 includes primary winding 161-1 (such as any suitable number of turns), primary winding 161-2 (such as any suitable number of turns), secondary winding 162-1 (such as any suitable number of turns), and secondary winding 162-2 (such as any suitable number of turns).

As previously discussed, the number of associated with the primary winding 161 and/or the secondary winding 162 can be any suitable value and vary depending on the example.

In a further example, a combination of the primary windings and secondary windings of multi-tapped autotransformer 160 are connected in series. For example, primary winding 161-1 (a.k. a., PRI1 such as including primary winding 161-11, and primary winding 161-12) is connected in series with secondary winding 162-1 (a.k.a., SEC1); secondary winding 162-1 is connected in series with secondary winding 162-2 (a.k. a., SEC2); secondary winding 162-2 is further connected in series with primary winding 161-2 (a.k. a., PRI2 such as including primary winding 161-21, and primary winding 161-22).

Thus, starting from the node N31 or node inP1 and ending at the node N32 or node outP2, the multi-tapped autotransformer 160 includes a series combination of: primary winding 161-12, primary winding 161-11, secondary winding 162-1, secondary winding 162-2, primary winding 161-22, and primary winding 161-21.

Thus, the node N31 is an end node or terminal node of the multi-tapped autotransformer 160, the node TN1 is a tap node of the primary winding PRI1 of the multi-tapped autotransformer 160, the node outP1 is a tap node of the multi-tapped autotransformer 160, the node com is a tap node of the multi-tapped autotransformer 160, the node inP2 is a tap node of the multi-tapped autotransformer 160, the node TN2 is a tap node of the primary winding PRI2 of the multi-tapped autotransformer 160, node N32 is an end or terminal node of the multi-tapped autotransformer 160, As shown, the primary winding 161-12, primary winding 161-11, secondary winding 162-1, secondary winding 162-2, primary winding 161-22, and primary winding 161-21 are each magnetically coupled to each other. If desired, the secondary winding 162 can be a center tapped winding, where the com node is the center tap node facilitating generation of the output voltage 123 from a respective output of the center-tapped winding.

Further in this example, the drain node (D) of switch Q1 and the drain node (D) of switch Q4 are both connected to the input voltage source 120 to receive the input voltage Vin.

Further, the source node(S) of the switch Q1 is coupled via node 213 to the drain node (D) of the switch Q2. The source node(S) of the switch Q4 is coupled via node 214 to the drain node (D) of the switch Q5. The source node(S) of the switch Q2 is coupled to the tap node TN1 via node 211. The source node(S) of the switch Q5 is coupled to the tap node TN2 via the node 212.

Capacitor Cres1 is connected between node 213 and a respective node N32 of the primary winding 161-21. Capacitor Cres2 is connected between node 214 and a respective node N31 of the primary winding 161-12.

Yet further, the drain (D) of switch Q3 is connected to node outP1 and node inS1; the source(S) of switch Q3 is connected to ground reference voltage 199. The drain (D) of switch Q6 is connected to node inP2 and node outS2; the source(S) of switch Q6 is connected to the ground reference voltage 199.

The center tap (com node) of the secondary winding of the multi-tapped autotransformer 160 outputs current iOUT and produces corresponding output voltage 123 (such as a DC voltage or substantially DC voltage) to supply power to the load 118 (a.k.a., Ro).

Further in this example, control signal 105-1 (also known as a signal S1) generated by the controller 140 drives gates (G) of respective switches Q1, Q3, and Q5. Accordingly, control signal 105-1 (signal S1) controls a state of each of the switches Q1, Q3, and Q5.

Control signal 105-2 (also known as signal S2) drives respective gates (G) of switches Q2, Q4, and Q6. Accordingly, control signal 105-2 (signal S2) controls a state of each of the switches Q2, Q4, and Q6.

Output stage 325 includes secondary windings of the multi-tapped autotransformer 160 as well as corresponding output capacitor Cout.

Note again that each of the switches as described herein can be any suitable devices such as (Metal Oxide Semiconductor) field effect transistors, bipolar junction transistors, etc.

The settings of capacitors Cres1 and Cres2 can be any suitable value. In one example, the voltage converter 135 as described herein provides better performance when Cres1=Cres2, and works well even if Cres1≠Cres2.

As previously discussed, switches in power supply 100 are divided into two switch groups: the first switch group including switches Q1, Q3, and Q5 controlled by respective control signal 105-1 (S1), and a second switch group including switches Q2, Q4, and Q6, controlled by respective control signal 105-to (S2), which is generally a 180 degrees phase shift with respect to timing of control signal 105-1.

In one example, the pulse width modulation of control signals 105 is approximately 50%. The magnitude of the output voltage 123 depends on the turns (# of windings ratio N1/N2 of the primary winding to the secondary winding). In one example, the switching frequency does not change directly the magnitude of the output voltage, but in general is changing it because the losses are increasing or decreasing based on the difference between Fres and Fsw, where Fres is the resonant frequency of the tank formed by Cres1 or Cres2 and the leakage of the multi-tapped autotransformer when Cres1=Cres2.

Note that a further benefit of the voltage converter 135 as described herein is the symmetric behavior of such a circuit. For example, as further discussed herein, via the implementation of power supply 100: i) the voltage converter 135 is powered almost continuously from the input supply Vin at different times in a respective control cycle, reducing the input current ripple as compared to other technologies, ii) in the equivalent resonant tank switched circuit paths of the switched-capacitor converter (such as first resonant circuit path including capacitor Cres1 and primary winding 161-2 and second resonant circuit path including capacitor Cres2 and primary winding 161-1), both resonant caps are resonating with the leakage inductance Lk of the multi-tapped autotransformer 160.

Thus, in this example, the voltage converter 135 (a.k.a., switched-capacitor converter) includes a first resonant circuit path between the node 213 and the tap node com including the capacitor CRES1, primary winding 161-21, primary winding 161-22, and secondary winding 162-2.

The voltage converter 135 also includes a second resonant circuit path between the node 214 and the tap node com including the capacitor CRES2, primary winding 161-12, primary winding 161-11, and secondary winding 162-1.

Thus, examples herein include the multi-tapped autotransformer 160 including a first secondary winding SEC1 and a second secondary winding SEC2 inductively coupled to the first primary winding PRI1 and the second primary winding PRI2. The output stage 325 of the voltage converter 135 can be configured to include the first secondary winding SEC1 and the second secondary winding SEC2.

Yet further, as previously discussed, the tap node (such as com node) of the multi-tapped autotransformer 160 directly couples the first secondary winding 162-1 and the second secondary winding 162-2 in series. The tap node com is operative to output the output voltage Vout to the load 118 and corresponding output capacitor Cout. The tap node PH1 of the multi-tapped autotransformer 160 directly couples the first primary winding PRI1 to the first secondary winding SEC1; the tap node PH2 of the multi-tapped autotransformer 160 directly couples the second primary winding PRI2 to the second secondary winding SEC2.

Thus, the switched-capacitor converter in FIG. 3 includes: i) a first resonant circuit path (capacitor CRES1 and second primary winding PRI2) selectively coupled to the first tap node TN1 of the first primary winding PRI1 depending on a state of switch Q2; and ii) a second resonant circuit path (capacitor CRES2 and primary winding PRI1) selectively coupled to the second tap node TN2 of the second primary winding PRI2 depending on a state of the second switchQ5.

Yet further, from another perspective, the switched-capacitor converter as discussed herein includes switch circuitry Q2 directly coupled to the first tap node TN1. The switch circuitry Q2 controls flow of the first current i1 into the first tap node TN1 and through a first portion (161-11) of the first primary winding PRI1 during mode #2. The switched capacitor converter as discussed herein further includes switch circuitry Q5 directly coupled to the second tap node TN2, where the second switch circuitry Q5 is configured to control flow of the second current i2 into the second tap node TN2 and through a first portion (161-22) of the second primary winding PRI2 during mode #1.

The first portion (161-11) of the first primary winding PRI1 is directly connected between the first tap node TN1 and node inS1 of the first secondary winding 162-1; the first portion (161-22) of the second primary winding PRI2 is connected between the second tap node TN2 and a node outS2 of the second secondary winding SEC2.

The voltage converter 135 (switched capacitor converter) further includes: i) switch circuitry Q3 directly connected between the node inS1 of the first secondary winding SEC1 and a ground reference 199, and ii) switch circuitry Q6 directly connected between the node outS2 of the second secondary winding SEC2 and the ground reference 199.

As previously discussed, the voltage converter 135 includes a controller 140 operative to control the switch circuitry Q1-Q6, where the control of the switch circuitry controls flow of the first current i1 into the first tap node TN1 and the second current i2 into the second tap node TN2.

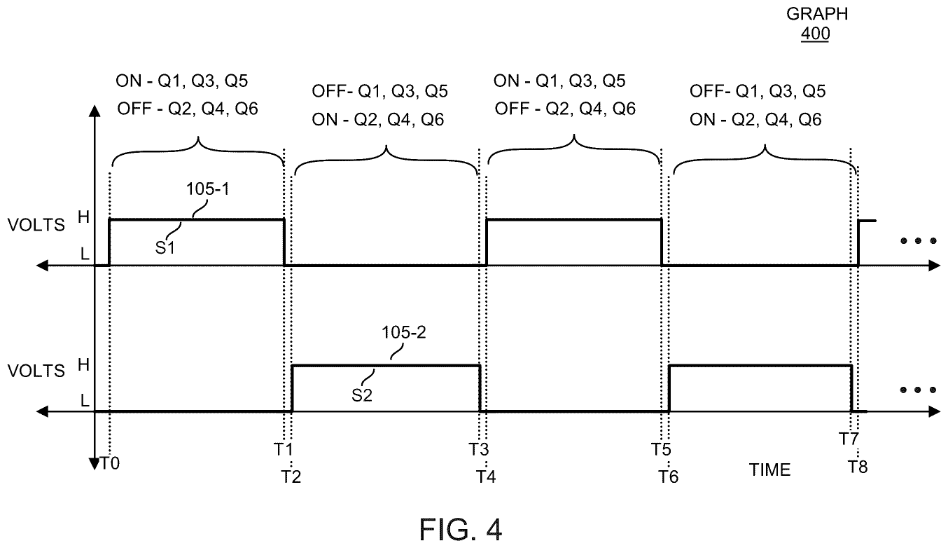

FIG. 4 is an example timing diagram illustrating timing of control signals as discussed herein.

In general, as shown in graph 400, the controller 110 produces the control signal 105-2 (a.k. a., S2) to be an inversion of control signal 105-1 (a.k.a., S1). A pulse width of each control signal is approximately 49% or other suitable pulse width modulation value.

Between time T0 and time T1, when the control signal 105-1 (at a logic high) controls the set of switches Q1, Q3, and Q5, to an ON state (low impedance or short circuit), the control signal 105-2 (logic low) controls the set of switches Q2, Q4, and Q6, to an OFF state (open circuit).

Conversely, between time T2 and time T3, when the control signal 105-2 (logic high) controls the set of switches Q2, Q4, and Q6, to an ON state, the control signal 105-1 (logic low) controls the set of switches Q1, Q3, and Q5, to an OFF state.

Note that the time duration between times T1 and time T2, the time duration between time T3 and time T4, time duration between T5 and T6, etc., represent so-called dead times during which each of the switches (Q1-Q6) in the power supply 100 is deactivated to the OFF state (high impedance or open circuit).

As further shown, the control signals 105 (such as signal S1 and signal S2) are cyclical. For example, the settings of control signals 105 for subsequent cycles is the same as those for the cycle between time T0 and time T4. More specifically, the settings of control signals 105 produced by the controller 140 between time T4 and time T8 is the same as settings of control signals 105 between time T0 and time T4, and so on.

In one example, the controller 140 can be configured to control the frequency of the control signals (period is time between T0 and time T4), which can be generated at any suitable frequency.

Additionally, as previously mentioned, the controller 110 controls the pulse duration of the control signals 105 to be around 49% depending on dead time, although the control signals 105 can be generated at any suitable pulse width modulation value.

In one example, in mode #1 between time T0 and time T1, based on control of switches, the controller 140: i) charges the first resonant capacitor CRES1 in the first portion (between time T0 and time T1) of a control cycle of operating the voltage converter 135 to convert an input voltage Vin into the output voltage Vout, and ii) discharges the second resonant capacitor CRES2 during the first portion (between time T0 and time T1) of the control cycle of operating the voltage converter 135, where the second capacitor CRES2 is discharged via the second current i2 inputted to the tap node TN2 of the second primary winding PRI2.

The controller 140, in mode #2, is further operative to: i) discharge the first resonant capacitor CRES1 during a second portion (between time T2 and time T3) of the control cycle of operating the voltage converter 135 to convert the input voltage into the output voltage, where the second capacitor CRES2 is discharged via the current i1 inputted to the tap node TN1 of the first primary winding PRI1, and ii) charge the second resonant capacitor CRES2 during the second portion of the control cycle of operating the voltage converter 135.

According to another perspective of operating the voltage converter 135, the controller 140 is operative to: i) activate the switch circuitry Q5 during a first portion (between time T0 and time T1) of a control cycle to input the current i2 through the second tap node TN2 to the second primary winding SEC2, ii) deactivate the switch circuitry Q5 during a second portion (between time T2 and time T3) of the control cycle to prevent input of the current i2 through the tap node TN2 to the second primary winding SEC2, iii) activate the switch circuitry Q2 during the second portion of the control cycle to input the current i1 through the tap node TN1 to the first primary winding PRI1, and iv) deactivate the switch circuitry Q2 during the first portion of the control cycle to prevent input of the current i1 through the second tap node TN2 to the second primary winding SEC2.

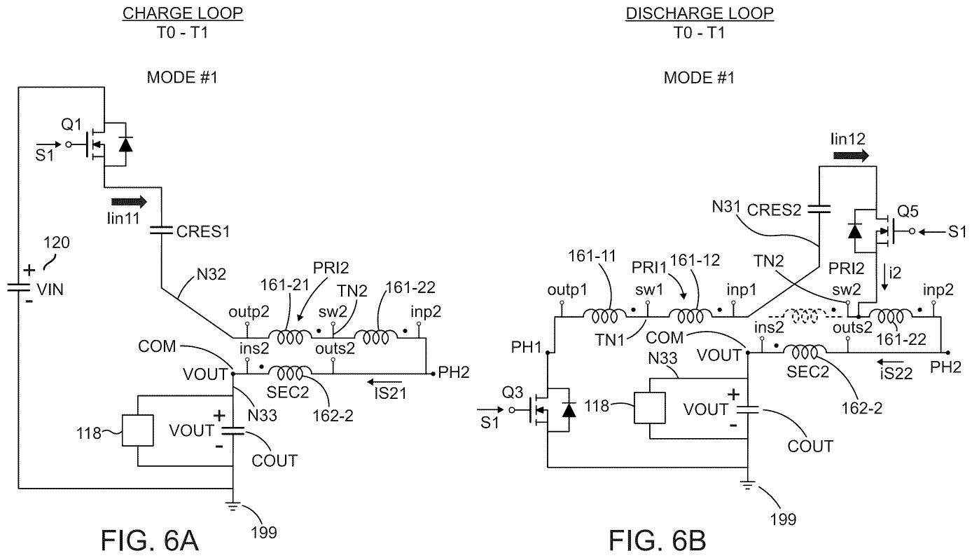

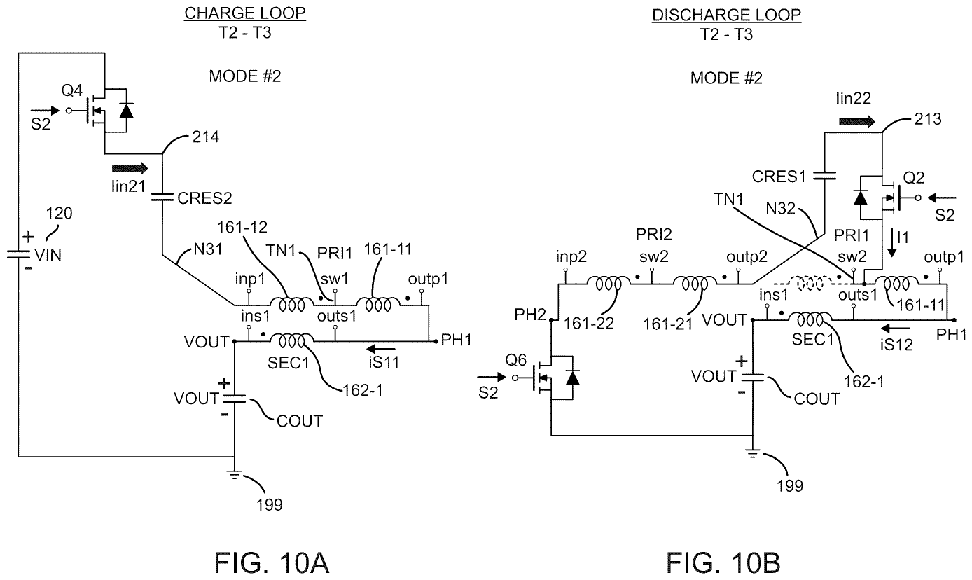

Yet further, from another perspective, the controller 140: i) controls the switch circuitry in accordance with a first mode (mode #1, see also FIGS. 6A and 6B) in which a first summation of current supplied by the second primary winding PRI2 to the second secondary winding includes the second current i2 inputted to the second tap node TN2 plus third current Iin11 or iS21 supplied from a first capacitor CRES1 of the multiple capacitors through the second primary winding SEC2, and ii) controls the switch circuitry in accordance with a second mode (mode #2, see also FIGS. 10A and 10B) in which a second summation of current supplied by the first primary winding (PRI1) to the first secondary winding SEC2 includes the first current i1 inputted to the first tap node TN1 plus fourth current Iin22 or iS11 supplied from a second capacitor CRES2 of the multiple capacitors through the first primary winding PRI1.

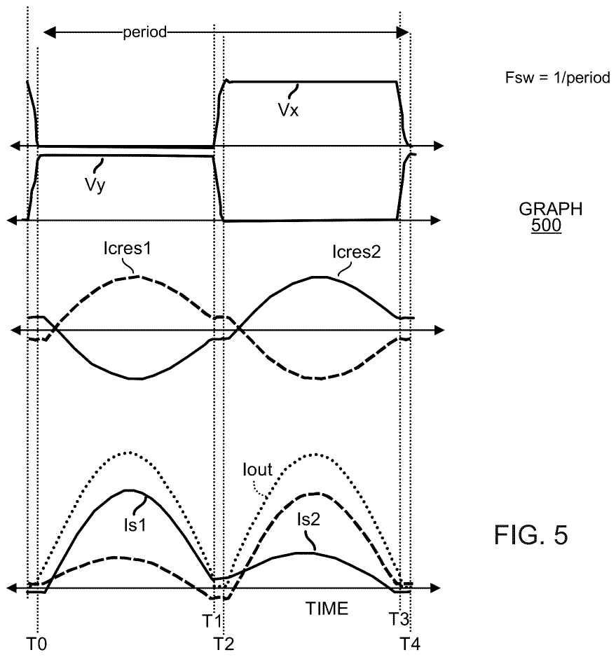

FIG. 5 is an example timing diagram illustrating control signals and output signals as discussed herein.

More specifically, as shown in graph 500, the voltage Vx indicates the voltage at node 211 (tap node TN1) between the primary winding 161-11 and the primary winding 161-12; voltage Vy indicates the voltage at node 212 (tap node TN2) of the primary winding 161-21 and primary winding 161-22.

Icres1 represents resonant current through the series combination of capacitor Cres1 and primary winding 161-21 and 161-22; Icres2 represents resonant current though the series combination of capacitor Cres2 and primary winding 161-12 and primary winding 161-11.

Signal is1 represents current through the secondary winding 162-1; signal is2 represents current though the secondary winding 162-2.

Iout (summation of current is1 and current is2) represents the output current (Iout) supplied by the center tap (tap node com) of secondary winding 162 of the multi-tapped autotransformer 160 to a dynamic load 118.

Between time T0 and time T1, when the resonant circuit path including capacitor Cres 1 is coupled to input voltage source 120 to receive the input voltage Vin via activation of switch Q1, the corresponding generated current is1 may contribute a majority of the current to produce the current Iout. Conversely, between time T2 and time T3, when the resonant circuit path including capacitor Cres 2 and primary winding 161-1 are coupled to input voltage via activation of switch Q2, the corresponding generated current is2 may contribute a majority of the current to produce the current Iout.

FIG. 6A and FIG. 6B are example diagrams illustrating a first mode of operating the switched capacitor converter as discussed herein.

As more particularly shown in FIG. 6A, activation of the switch Q1 to the ON-state between time T0 and time T1 results in a charging loop, where the capacitor CRES1 is charged and the current Iin11 flows from the input voltage source 120 through the switch Q1 and the resonant capacitor CRES1 through a series winding circuit path including the combination of 161-21, primary winding 161-22, and the secondary winding 162-2. In such an instance, the charging loop in FIG. 6A in the first mode (mode #1) includes supplying current iS21 from the com node to the capacitor Cout and corresponding load 118.

As more particularly shown in FIG. 6B, activation of the switches Q3 and Q5 to the ON-state between time T0 and time T1 results in a discharging loop and the capacitor CRES2 is discharged and the current Iin12 (a.k.a., i2) flows from the ground reference voltage 199 through the series circuit path including primary winding 161-11, primary winding 161-12, resonant capacitor CRES2, activated switch Q5, primary winding 161-22, and secondary winding 162-2 through the node com to the load 118. In such an instance, the discharging loop in FIG. 6B in the first mode (mode #1) includes supplying current iS22 from the com node to the capacitor Cout and corresponding load 118. Thus, the current Iin12 or i2 is supplied into the tap node TN2 during mode #1.

During the first mode between time T0 and time T1, the multi-tapped autotransformer 160 produces the output voltage Vout by supplying a summation of current iS21 and iS22 to the load 118 and corresponding output capacitor Cout.

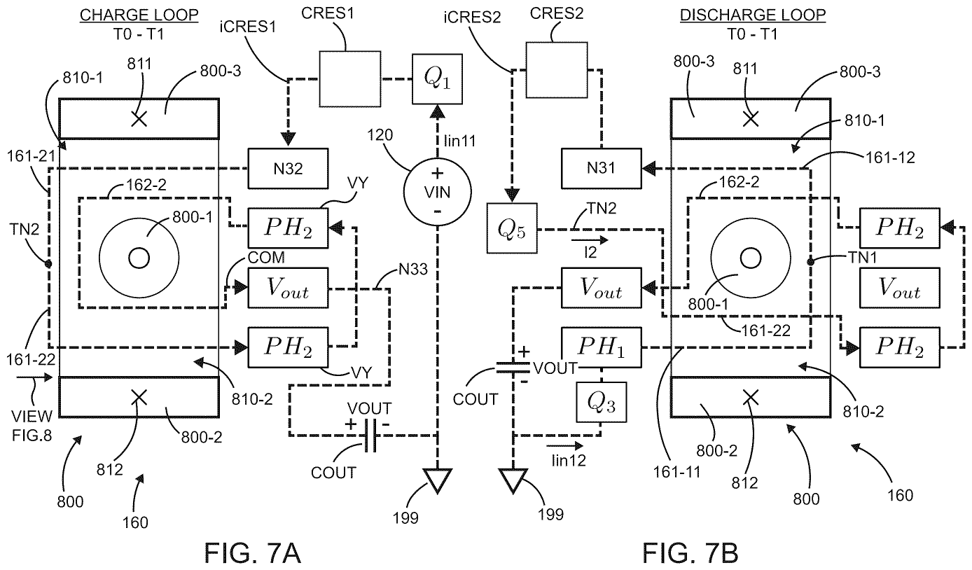

FIG. 7 is an example diagram illustrating flow of currents through a multi-tapped autotransformer and generation of a corresponding output voltage during the first mode as discussed herein.

In this example, the multi-tapped autotransformer 160 includes the assembly of electrically conductive paths (dashed lines-------- as illustrated in FIG. 7) providing connectivity between the components of the switched-capacitor converter and conveying corresponding current. Thus, the dashed lines indicate electrically conductive paths between respective nodes as well as corresponding current flows. Electrically conductive paths passing through the magnetically permeable material 800 represent windings of the multi-tapped autotransformer 160.

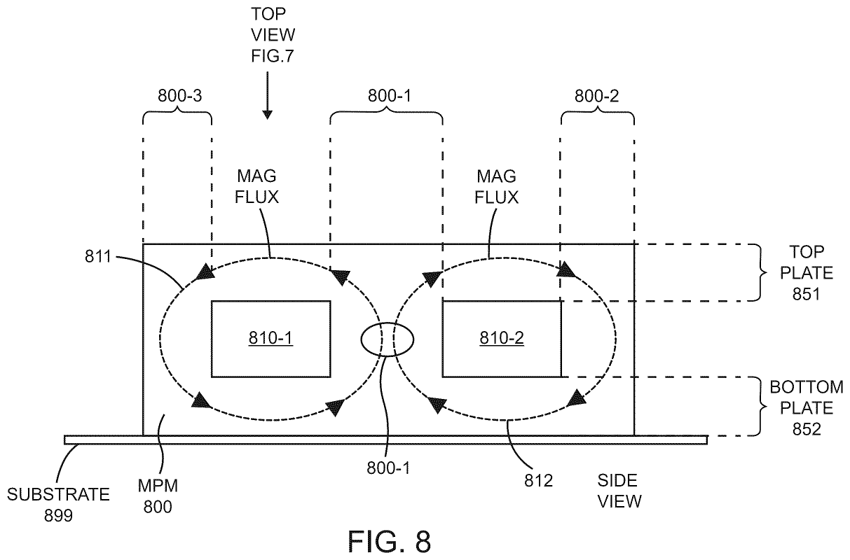

Yet further, the top view diagram of the voltage converter 135 and corresponding components in FIG. 7A in FIG. 7 B illustrate possible placement on a circuit board (such as host substrate 899 shown in FIG. 8) as well as implementation of corresponding electrical paths through the magnetically permeable material 800 associated with the multi-tapped autotransformer 160.

More specifically, in this example of FIG. 7A and FIG. 7B, the magnetic permeable material 800 associated with the multi-tapped autotransformer can be configured to include a first channel 810-1 and a second channel 810-2 through which the corresponding electrically conductive path associated with the windings of the multi-tapped autotransformer pass. For example, the channel 810-1 may be created via the center portion of magnetically permeable material 800-1 extending out of the page, side portion of magnetically permeable material 800-2 extending out of page, and the side portion of magnetic permeable material 800-3 extending out of the page. A side view diagram of the magnetically permeable material 800 (transformer assembly) in FIG. 7A in FIG. 7B is further shown in FIG. 8.

FIG. 8 is a side view diagram illustrating magnetically permeable material associated with the multi-tapped autotransformer of FIG. 7 discussed herein.

In this example, the assembly of magnetically permeable material 800 (magnetic core of the multi-tapped autotransformer 160) includes bottom plate 852 of magnetically permeable material, top plate 851 of magnetic permeable material, side portion of magnetically permeable material 800-2, center portion of magnetically permeable material 800-1, and side portion of magnetically permeable material 800-3.

The assembly of magnetically permeable material 800, corresponding electrically conductive paths, as well as the circuit components (such as switches Q1-Q6), resonant capacitors CRES1 and CRES2, controller 140, etc., can be disposed on a respective host substrate 899 such as a printed circuit board or other suitable entity.

As further shown in the side view of the magnetically permeable material 800 (a.k.a., magnetic core associated with the multi-tapped transformer 160), the flow of current through the primary winding and/or secondary windings associated with the multi-tapped autotransformer 160 produces magnetic flux.

More specifically, flow of variable current through the electrically conductive paths (primary winding and/or secondary winding) extending through the channel 810-1 produces the magnetic flux 811 in the magnetic permeable material surrounding the channel 810-1 as shown. Additionally, flow of current through the electrically conductive paths (primary winding and/or secondary winding) through the channel 810-2 produces the magnetic flux 812 in the magnetically permeable material surrounding the channel 810-2 as shown. As previously discussed, FIG. 7A in FIG. 7B are each a cutaway top view of the magnetic permeable material 800 (assembly) to illustrate possible placement of components and windings associated with the voltage converter 135.

Referring again to FIG. 7A, it is noted that the top view of the voltage converter 135 illustrates the charge loop operation between time T0 and time T1. Additionally, referring again to FIG. 7B, it is noted that the top view of the voltage converter 135 illustrates the discharge loop operation between time T0 and time T1.

Via the right-hand rule, as shown in the charge loop of FIG. 7A, the flow of current Iin11 counterclockwise through the primary winding 161-21 and the primary winding 161-22 in the charge loop results in magnetic flux directed out of the magnetically permeable material 800-1, which then returns through side portion of magnetic permeable material 800-3 and side portion of magnetically permeable material 800-2 through the top plate 851. The secondary winding 162-2 receives the energy from the primary winding to produce the output voltage as previously discussed.

Via the right-hand rule, as shown in the discharge loop of FIG. 7B, the flow of current Iin12 counterclockwise through the primary winding PR1 (primary winding 161-11 and the primary winding 161-12) as well as flow of current i2 counterclockwise through the primary winding 161-22 in the discharge loop results in magnetic flux directed out of the magnetically permeable material 800-1 which then returns through magnetic permeable material 800-3 and magnetically permeable material 800-2 through the top plate 851. The secondary winding 162-2 receives the energy from the primary winding to produce the output voltage Vout as previously discussed.

Accordingly, primary winding PRI1 may be tapped with a switching node sw1 (a.k.a., TN1). Considering the power supply assembly in FIGS. 7A and 7B, no additional external copper to the transformer area is necessarily needed to close the discharging loop, increasing power density. Furthermore, in the same phase the charging loop current is flowing at the right of the core, meanwhile the discharging loop current is flowing at the left. This provides better thermal performance, as the current is distributed among all the printed circuit board (PCB) area on which the components of the voltage converter 135 are mounted.

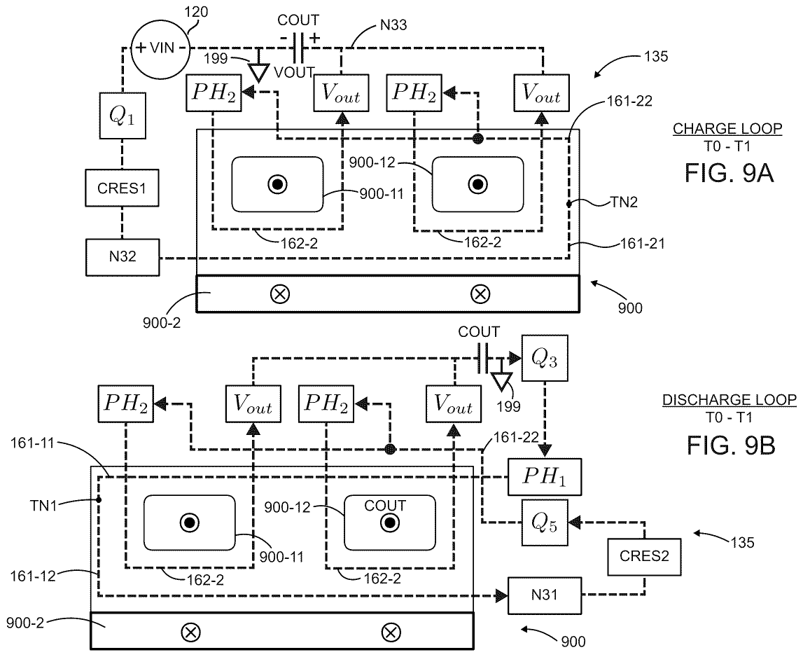

FIG. 9A and FIG. 9B are example diagrams illustrating flow of current through a multi-tapped autotransformer and generation of a corresponding output voltage during the first mode and second mode as discussed herein.

In this example, the implementation of the multi-tapped autotransformer 160 includes the core of magnetically permeable material 900. The core of magnetically permeable material 900 includes side portion of magnetic permeable material 900-2 as well as first center portion of magnetically permeable material 900-11 and second center portion of magnetic permeable material 900-12.

In a similar manner as previously discussed with respect to FIG. 8, the core of magnetically permeable material 900 includes a bottom portion and a top portion, where the side portion of magnetically permeable material 900-2, first center portion of magnetic permeable material 900-11, and second center portion of magnetically permeable material 900-12 are disposed between a top plate of magnetically permeable material and a bottom plate of magnetic permeable material of the magnetic permeable material 900 (assembly).

Referring again to FIGS. 9A and 9B, it is noted that the top views of the voltage converter 135 illustrates the charge loop operation (FIG. 9A) between time T0 and time T1 and the discharge loop operation (FIG. 9B) between time T0 and time T1.

Via the right-hand rule, as shown in the charge loop of FIG. 9A, the flow of current counterclockwise through the primary winding 161-21 and the primary winding 161-22 in the charge loop results in magnetic flux directed out of the magnetically permeable material 900-11 and 900-12 which then returns through side portion of magnetic permeable material 900-2 through a respective top plate. The secondary winding 162-2 (such as multiple electrically conductive paths around magnetic permeable material 900-11 and magnetic permeable material 900-12) receives the energy from the primary winding to produce the output voltage as previously discussed.

Via the right-hand rule, as shown in the discharge loop of FIG. 9B, the flow of current counterclockwise through the primary winding 161-11 and primary winding 161-12 in the discharge loop results in magnetic flux directed out of the magnetically permeable material 900-11 and 900-12 which then returns through magnetic permeable material 900-2. The secondary winding 162-2 (such as multiple electrically conductive paths around magnetic permeable material 900-11 and magnetic permeable material 900-12) receives the energy from the primary winding to produce the output voltage as previously discussed.

FIGS. 10A and 10B are example diagrams illustrating a second mode of operating the switched capacitor converter as discussed herein.

As more particularly shown in FIG. 10A, activation of the switch Q1 to the ON-state between time T2 and time T3 results in a charging loop, where the capacitor CRES2 is charged and the current Iin21 flows from the input voltage source 120 through the activated switch Q4 and the resonant capacitor CRES2 through a series winding circuit path including the combination of 161-12, primary winding 161-11, and the secondary winding 162-1. In such an instance, the charging loop in FIG. 10A in the second mode (mode #2) includes supplying current iS11 from the com node to the capacitor Cout and corresponding load 118.

As more particularly shown in FIG. 10B, activation of the activated switches Q3 and Q5 to the ON-state between time T2 and time T3 results in a discharging loop and the capacitor CRES1 is discharged and the current Iin22 flows from the ground reference voltage 199 through the series circuit path including primary winding 161-22, primary winding 161-21, resonant capacitor CRES1, switch Q2, primary winding 161-11, and secondary winding 162-1 through the node com and the load 118. In such an instance, the discharging loop in FIG. 10B in the first mode (mode #2) includes supplying current iS12 from the com node to the capacitor Cout and corresponding load 118. Thus, the current Iin22 or i1 is supplied into the tap node TN1 during mode #2.

During the second mode between time T2 and time T2, the multi-tapped autotransformer 160 supplies a summation of current iS11 and iS12 to the load 118 and corresponding output capacitor Cout.

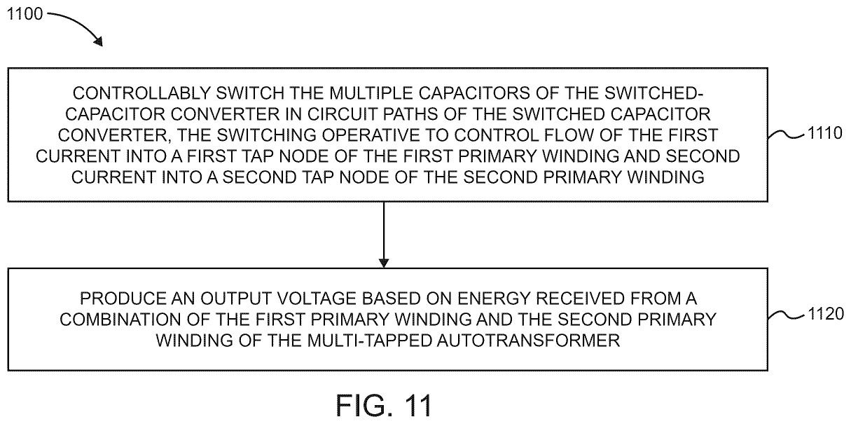

FIG. 11 is a flowchart 1100 illustrating an example method according to examples herein. Note that there will be some overlap with respect to concepts as discussed above.

In processing operation 1110, the controller 140 switches the multiple capacitors of the switched-capacitor converter in circuit paths of the switched capacitor converter. As discussed herein, the switching is operative to control flow of first current into a first tap node of the first primary winding and second current into a second tap node of the second primary winding.

In processing operation 1120, the output stage produces an output voltage based on energy received from a combination of the first primary winding and the second primary winding of the multi-tapped autotransformer.

Note again that techniques herein are well suited for use in multi-tapped autotransformer and power supply applications. However, it should be noted that examples herein are not limited to use in such applications and that the techniques discussed herein are well suited for other applications as well.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. A switched-capacitor converter comprising:
multiple capacitors;
a multi-tapped autotransformer including a first primary winding and a second primary winding, the multiple capacitors disposed in circuit paths of the switched-capacitor converter including the first primary winding and the second primary winding, the first primary winding including a first tap node to receive first current, the second primary winding including a second tap node to receive second current; and
an output stage operative to produce an output voltage to power a load based on energy received from a combination of the first primary winding and the second primary winding of the multi-tapped autotransformer.

2. The switched-capacitor converter as in claim 1, wherein the multi-tapped autotransformer further includes a first secondary winding and a second secondary winding inductively coupled to the first primary winding and the second primary winding; and
wherein the output stage includes the first secondary winding and the second secondary winding.

3. The switched-capacitor converter as in claim 2, wherein a third tap node of the multi-tapped autotransformer directly couples the first secondary winding and the second secondary winding in series, the third tap node operative to output the output voltage.

4. The switched-capacitor converter as in claim 3, wherein a fourth tap node of the multi-tapped autotransformer directly couples the first primary winding to the first secondary winding; and
wherein a fifth tap node of the multi-tapped autotransformer directly couples the second primary winding to the second secondary winding.

5. The switched-capacitor converter as in claim 4, wherein the switched circuit paths include: i) a first resonant circuit path coupled to the first tap node of the first primary winding via a first switch, the first resonant circuit path including a first capacitor of the multiple capacitors, and ii) a second resonant circuit path coupled to the second tap node of the second primary winding via a second switch, the second resonant circuit path including a second capacitor of the multiple capacitors.

6. The switched-capacitor converter as in claim 1 further comprising:
first switch circuitry directly coupled to the first tap node, the first switch circuitry operative to control flow of the first current into the first tap node and through a first portion of the first primary winding; and
second switch circuitry directly coupled to the second tap node, the second switch circuitry operative to control flow of the second current into the second tap node and through a first portion of the second primary winding.

7. The switched-capacitor converter as in claim 6, wherein the first portion of the first primary winding is directly connected between the first tap node and a first node of the first secondary winding; and
wherein the first portion of the second primary winding is connected between the second tap node and a first node of the second secondary winding.

8. The switched-capacitor converter as in claim 7 further comprising:
third switch circuitry directly connected between the first node of the first secondary winding and a ground reference; and
fourth switch circuitry directly connected between the first node of the second secondary winding and the ground reference.

9. The switched-capacitor converter as in claim 1, wherein the multiple capacitors include a first resonant capacitor and a second resonant capacitor;
wherein the first resonant capacitor is disposed in series with the second primary winding; and
wherein the second resonant capacitor is disposed in series with the first primary winding.

10. The switched-capacitor converter as in claim 9 further comprising:
a controller operative to: i) charge the first resonant capacitor during a first portion of a control cycle of operating the switched-capacitor converter to convert an input voltage into the output voltage, and ii) discharge the second resonant capacitor during the first portion of the control cycle of operating the switched-capacitor converter, the second capacitor discharged via the second current inputted to the second tap node of the second primary winding.

11. The switched-capacitor converter as in claim 10, wherein the controller is further operative to: i) discharge the first resonant capacitor during a second portion of the control cycle of operating the switched-capacitor converter to convert the input voltage into the output voltage, the second capacitor discharged via the first current inputted to the first tap node of the first primary winding, and ii) charge the second resonant capacitor during the second portion of the control cycle of operating the switched-capacitor converter.

12. The switched-capacitor converter as in claim 1 further comprising:
first switch circuitry;
second switch circuitry; and
a controller operative to: i) activate the first switch circuitry during a first portion of a control cycle to input the second current through the second tap node to the second primary winding, ii) deactivate the first switch circuitry during a second portion of the control cycle to prevent input of the second current through the second tap node to the second primary winding, iii) activate the second switch circuitry during the second portion of the control cycle to input the first current through the first tap node to the first primary winding, and iv) deactivate the second switch circuitry during the first portion of the control cycle to prevent input of the first current through the first tap node to the second primary winding.

13. The switched-capacitor converter as in claim 1 further comprising:
switch circuitry; and
a controller operative to: i) control the switch circuitry in accordance with a first mode in which a first summation of current supplied by the second primary winding to the second secondary winding includes the second current inputted to the second tap node plus third current supplied from a first capacitor of the multiple capacitors through the second primary winding, and ii) control the switch circuitry in accordance with a second mode in which a second summation of current supplied by the first primary winding to the first secondary winding includes the first current inputted to the first tap node plus fourth current supplied from a second capacitor of the multiple capacitors through the first primary winding.

14. The switched-capacitor converter as in claim 1 further comprising:
switch circuitry; and
a controller operative to control the switch circuitry, the control of the switch circuitry controlling flow of the first current into the first tap node and the second current into the second tap node.

15. In a switched-capacitor converter including multiple capacitors and a multi-tapped autotransformer including a first primary winding and a second primary winding, a method comprising:
switching the multiple capacitors of the switched-capacitor converter in circuit paths of the switched capacitor converter, the switching operative to control flow of first current into a first tap node of the first primary winding and second current into a second tap node of the second primary winding; and
producing an output voltage based on energy received from a combination of the first primary winding and the second primary winding of the multi-tapped autotransformer.

16. The method as in claim 15, wherein the multi-tapped autotransformer further includes a first secondary winding and a second secondary winding inductively coupled to the first primary winding and the second primary winding;
wherein the output stage includes the first secondary winding and the second secondary winding, the method further comprising:
via a first node of the multi-tapped autotransformer directly coupling the first secondary winding and the second secondary winding in series, outputting the output voltage.

17. The method as in claim 15, wherein switching the multiple capacitors in the switched-capacitor converter includes controlling resonant operation of the circuit paths.

18. The method as in claim 15, wherein the multiple capacitors include a first capacitor and a second capacitor;
wherein the first capacitor is disposed in series with the second primary winding of the switched-capacitor converter to form a first resonant circuit path;
wherein the second capacitor is disposed in series with the first primary winding to form a second resonant circuit path; and.
wherein switching the multiple capacitors includes: i) charging the first resonant capacitor during a first portion of a control cycle of operating the switched-capacitor converter to convert an input voltage into the output voltage, and ii) discharging the second resonant capacitor during the first portion of the control cycle of operating the switched-capacitor converter, the second capacitor discharged via the second current inputted to the second tap node of the second primary winding.

19. The method as in claim 18, wherein switching the multiple capacitors includes: i) discharging the first resonant capacitor during a second portion of the control cycle of operating the switched-capacitor converter to convert the input voltage into the output voltage, the second capacitor discharged via the first current inputted to the first primary winding via the first tap node, and ii) charging the second resonant capacitor during the second portion of the control cycle of operating the switched-capacitor converter.

20. The method as in claim 15, wherein the switched-capacitor converter includes first switch circuitry and second switch circuitry; and
wherein switching the multiple capacitors includes: i) activating the first switch circuitry during a first portion of a control cycle to input the second current through the second tap node to the second primary winding, ii) deactivating the first switch circuitry during a second portion of the control cycle to prevent input of the second current through the second tap node to the second primary winding, iii) activating the second switch circuitry during the second portion of the control cycle to input the first current through the first tap node to the first primary winding, and iv) deactivating the second switch circuitry during the first portion of the control cycle to prevent input of the first current through the first tap node to the second primary winding.
